(19) United States
(12) Patent Application Publication
(10) Pub. No.: US 2005/0286958 A1
(43) Pub. Date: Dec. 29, 2005

(54) Thermal transfer printer

(75) Inventor: Masami Shiratori, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/165,856

(22) Filed: Jun. 24, 2005

(30) Foreign Application Priority Data
Jun. 28, 2004 (JP) 2004-190054

(51) Int. Cl. B41J 15/16; B41J 13/02; B41J 2/32

(52) U.S. Cl. 400/642; 400/120.18

(57) ABSTRACT

A thermal transfer printer including a thermal head, a platen, a rotatable transport roller and a pinch roller, where a decurling roller is provided between the thermal head and the transport roller, the decurling roller contactable with the heated side of the sheet heated with the thermal head, thereby curving the sheet with its heated side being concaved. A guide roller may also be provided that is located between the thermal head and the decurling roller, the guide roller being contactable with the side of the sheet opposite the heated side. In this way, it is possible to reduce warpage of a sheet caused by the heating by the thermal head.

### BACKGROUND OF THE INVENTION

1. Field of the Invention

The present invention relates to a thermal transfer printer that forms an image on a sheet of paper using a thermal head to heat the sheet, and more particularly, to a thermal transfer printer that allows printing on a sheet of paper with decreased warpage.

2. Description of the Background Art

Conventionally, thermal transfer printers are in use that employ a thermal head to heat a sheet of paper to form an image on the sheet. For this purpose, a sheet may include a layer of heat sensitive dye applied thereon that is heated by a thermal head to a predetermined temperature to produce a predetermined color. Alternatively, a printer ribbon may be brought into close contact with a sheet and heated by a thermal head to transfer a color from the ribbon (sublimation printing).

Such a thermal transfer printer includes a thermal head 11 and a transport roller 21, as shown in FIG. 4. Thermal head 11 is disposed opposite a platen 14, downstream from which rotatable transport roller 21 is disposed opposite a pinch roller 24. A guide roller 31 is provided between thermal head 11 and pinch roller 24. As shown in FIG. 4, platen 14, guide roller 31 and transport roller 21 are arranged so as to form a straight tangent line along sheet 61.

Although different in specific structure from a thermal transfer printer as in FIG. 4, Japanese Utility Model Laying-Open No. 60-003751, Japanese Patent Laying-Open No. 10-265110, Japanese Utility Model Laying-Open No. 04-019541, and Japanese Patent Laying-Open No. 07-267449 describe printers including a mechanism that corrects curling of rolled paper.

A thermal transfer printer requires sheet 61 to be heated by thermal head 11. Unfortunately, heating sheet 61 may cause warpage of sheet 61 with the heated side being convex.

A printer as described in any of the four documents mentioned above includes a mechanism that corrects curling of rolled paper. Although such a printer allows reducing curling of rolled paper, warpage of sheet 61 caused by the heating by thermal head 11 is not accounted for and thus cannot be corrected.

### SUMMARY OF THE INVENTION

An object of the present invention is to provide a thermal transfer printer that allows reducing warpage of a sheet of paper caused by the heating by a thermal head.

A thermal transfer printer according to the present invention includes: a thermal head contactable with a sheet of paper to heat a side of the sheet; a platen disposed opposite the thermal head to press the sheet onto the thermal head; a rotatable transport roller located downstream from the thermal head with respect to the process of heating the sheet with the thermal head, the transport roller transporting the sheet held between the thermal head and the platen to be pulled out; a pinch roller disposed opposite the transport roller to press the sheet onto the transport roller; and a decurling roller located between the thermal head and the transport roller, the decurling roller being contactable with the heated side of the sheet heated by the thermal head, thereby curving the sheet with the heated side being concaved.

In the above thermal transfer printer, a guide roller may be provided between the thermal head and the decurling roller, the guide roller being contactable with the side of the sheet opposite the heated side.

In the above thermal transfer printer, the transport roller may be contactable with the side of the sheet opposite the heated side.

In the above thermal transfer printer, the sheet may be a sheet of thermal paper provided with a layer of heat sensitive dye which, when irradiated with ultraviolet light, allows an image formed by the heating by the thermal head to be fixed.

The thermal transfer printer according to the present invention includes a decurling roller downstream from the thermal head to curve the sheet with its heated side being concaved, thereby achieving the reduction of warpage of the sheet caused by the heating by the thermal head.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates an arrangement of major components of a thermal transfer printer in an embodiment of the present invention.

FIG. 2 illustrates the arrangement of major components of the thermal transfer printer in the embodiment of the present invention.

FIG. 3 illustrates the arrangement of major components of the thermal transfer printer in the embodiment of the present invention.

FIG. 4 illustrates an arrangement of major components of a conventional thermal transfer printer.

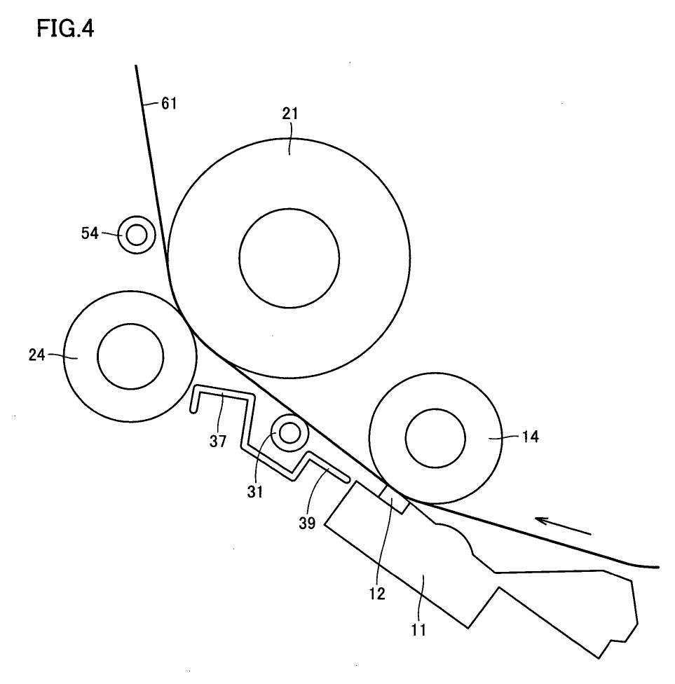

### DESCRIPTION OF THE PREFERRED EMBODIMENTS

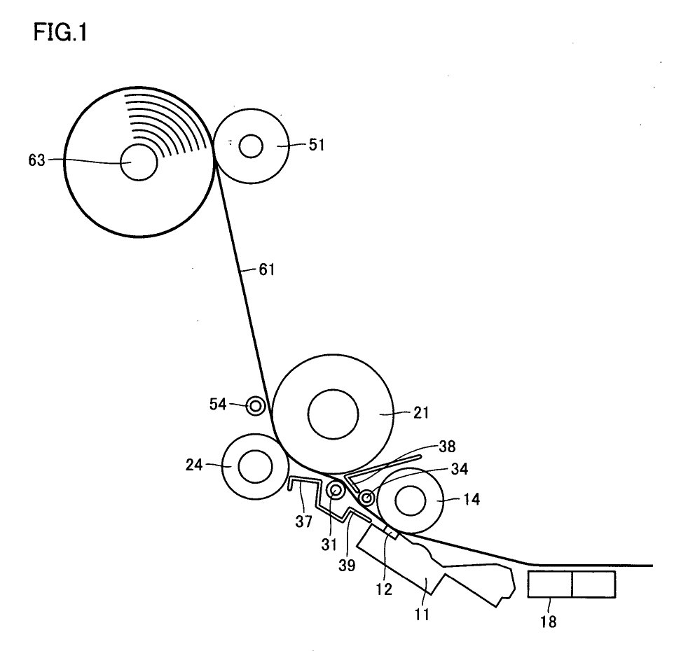

Now, a description of a thermal transfer printer according to an embodiment of the present invention is provided referring to FIGS. 1 to 3.

A thermal transfer printer of the present embodiment includes: a thermal head 11 contactable with a sheet of paper 61 to heat the side of sheet 61 to be heated; a platen 14 disposed opposite thermal head 11 to press sheet 61 onto thermal head 11; a rotatable transport roller 21 located downstream from thermal head 11 with respect to the process of heating sheet 61 with thermal head 11, the transport roller transporting sheet 61 held between thermal head 11 and platen 14 to be pulled out; a pinch roller 24 disposed opposite transport roller 21 to press sheet 61 onto transport roller 21; a decurling roller 31 located between thermal head 11 and transport roller 21, the decurling roller being contactable with the heated side of sheet 61 heated by thermal head 11 to curve sheet 61 with its heated side being concaved; and a guide roller 34 located between thermal head 11 and decurling roller 31, the guide roller being contactable with the side of sheet 61 opposite the heated side, where transport roller 21 is contactable with the side of sheet 61 opposite the heated side, and sheet 61 is a sheet of thermal paper that includes a layer of heat sensitive dye which, when irradiated with ultraviolet light, allows an image formed by the heating by thermal head 11 to be fixed.

As shown in FIG. 1, sheet 61 in the present embodiment is a sheet of rolled paper that is incorporated in the printer, wrapped around an axis 63. To advance sheet 61 wrapped around axis 63 toward a printing station that includes a thermal head 11 and other components, a feed roller 51 is provided in touch with the periphery of the paper roll. Feed roller 51 may be rotated to advance the rolled paper to the printing station.

To guide the front edge of sheet 61 advanced toward the printing station by feed roller 51, a feed guide roller 54 is provided in front of transport roller 21. Sheet 61, guided by feed guide roller 54, is held between transport roller 21 and opposing pinch roller 24. Transport roller 21 is rotated by a motor.

Sheet 61 is in contact with transport roller 21 when advanced toward the printing station. A first paper guide 37 is provided between transport roller 21 and the printing station. A decurling roller 31 is provided adjacent to first paper guide 37. A second paper guide 38 is provided opposite decurling roller 31. Moreover, a guide roller 34 is provided adjacent to second paper guide 38. The way how decurling roller 31 and guide roller 34 work will be described below. A third paper guide 39 is provided opposite guide roller 34.

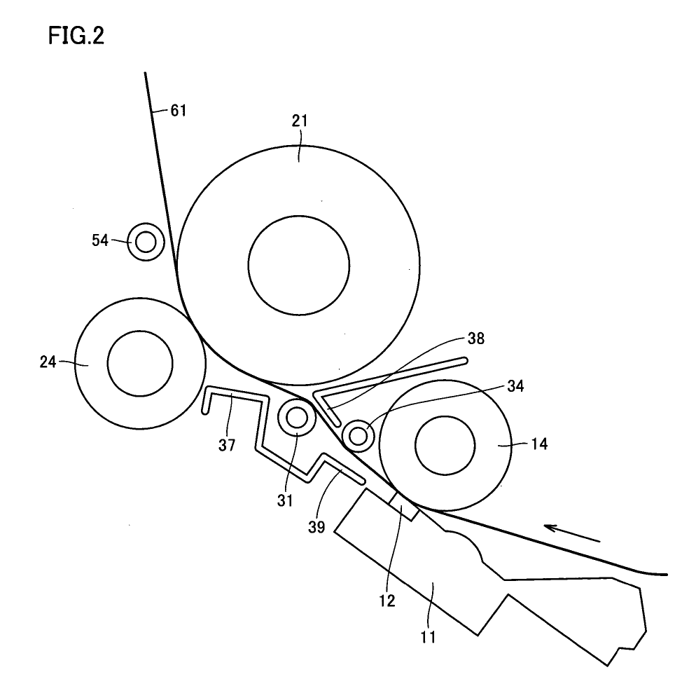

Sheet 61 fed into the printing station is passed between thermal head 11 and platen 14 before being advanced to the far-right portion of FIGS. 1 and 2. While FIGS. 1 and 2 show thermal head 11 and platen 14 leaving no gap therebetween, thermal head 11 is configured to be freely movable. Thermal head 11 is capable of being moved between a heating position where sheet 61 is heated, as shown in FIGS. 1 and 2, and a feeding position where the head and platen 14 leave a gap therebetween.

During feeding with sheet 61 and fixing for a heat sensitive dye as described below, thermal head 11 is moved to the feeding position, i.e. the head and platen 14 leave a gap therebetween. During heating of sheet 61, thermal head 11 is moved in contact with platen 14. Thermal head 11 has a heating section 12, the temperature of which may be changed to various temperatures depending on the color to be produced.

A fixing device 18 is provided adjacent thermal head 11. Fixing device 18 incorporates an ultraviolet lamp that causes the fixation of a color of the heat sensitive dye that was produced by the heating by thermal head 11. Two types of ultraviolet lamps are incorporated corresponding to the colors produced by the heat sensitive dye.

Before sheet 61 is heated with thermal head 11 to produce color from the heat sensitive dye, it is advanced to the far-right portion of FIGS. 1 and 2. Thermal head 11 is then moved to the heating position to hold sheet 61 between it and platen 14. Subsequently, sheet 61 is moved back to the left in FIGS. 1 and 2 by rotated transport roller 21.

The heat sensitive dye on sheet 61 consists of three layers: yellow, magenta and cyan, which produce color at respective temperatures. First, thermal head 11 heats the sheet to a temperature suitable for the yellow heat sensitive dye to produce the yellow. Once the production of the yellow is completed, the front edge of sheet 61 is advanced to the right and then moved back to the left while it is irradiated with an ultraviolet light for the yellow heat sensitive dye from fixing device 18, thereby fixing the yellow.

Next, the front edge of sheet 61 is advanced again to the right and then moved to the left while it is heated by thermal head 11 to a temperature suitable for the magenta heat sensitive dye to produce the magenta. After the magenta is produced, sheet 61 is moved to the right and is irradiated with an ultraviolet light for the magenta heat sensitive dye from fixing device 18, thereby fixing the magenta.

Subsequently, while sheet 61 is moved to the left, it is heated by thermal head 11 to a temperature suitable for the cyan heat sensitive dye to produce the cyan. Cyan is produced at a very high temperature and thus fixation is unnecessary. The production of the cyan completes the printing. Thus, in a thermal transfer printer of the present embodiment, sheet 61 needs to be moved back and forth four times until the completion of the printing.

Typically, heating a sheet with a thermal head of a thermal transfer printer causes warpage of the sheet with the heated side being convex. This is particularly significant when sheet 61 is heated multiple times as in a thermal transfer printer of the present embodiment. Accordingly, a thermal transfer printer of the present embodiment imparts curvature to sheet 61 heated by thermal head 11 with its heated side being concaved by the combined use of guide roller 34, transport roller 21 and decurling roller 31.

Guide roller 34 and decurling roller 31 are adjacent each other and provided downstream with respect to the process of heating with thermal head 11. This will impart curvature to sheet 61 with its heated side being concaved directly after the heating by thermal head 11, i.e. while sheet 61 is still warm, whereby warpage of sheet 61 due to the heating can be effectively corrected.

Further, the present embodiment provides decurling roller 31 close to guide roller 34 such that decurling roller 31 is capable of providing sheet 61 with a curvature having a relatively small radius, which can further ensure that warpage of sheet 61 is corrected.

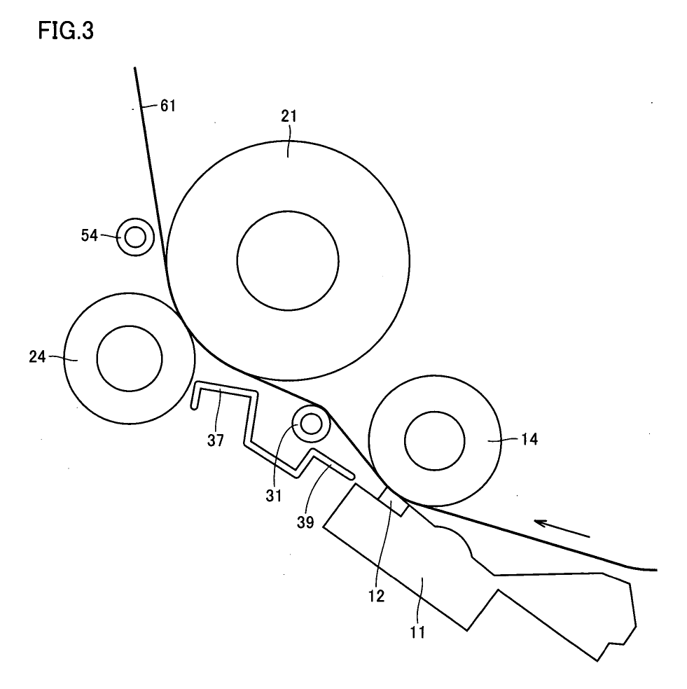

To provide a simpler structure of the thermal transfer printer, guide roller 34 may be omitted and, as shown in FIG. 3, curvature may be imparted to sheet 61 with its heated side being concaved by the combined use of decurling roller 31, platen 14 and transport roller 21, which still allows some of warpage of sheet 61 to be corrected.

It should be noted that, while the present embodiment described a thermal transfer printer using a sheet of paper 61 having a heat sensitive dye, a sublimation printer may be constructed where a ribbon is brought into contact with a sheet and heated to form an image on the sheet. This also enables imparting curvature to a sheet with its heated side being concaved by providing a decurling roller as described above downstream from a thermal head, whereby warpage of the sheet caused by the heating can be corrected.

Further, the present embodiment disposes platen 14 and transport roller 21 on the same side of sheet 61. In this way, transport roller 21 is in contact with the backside of sheet 61 (the side opposite the heated side), such that damage to the surface (heated side) of sheet 61 can be minimized. However, such an arrangement can be modified depending on the arrangement of the apparatus.

Although the present invention has been described and illustrated in detail, it is clearly understood that the same is by way of illustration and example only and is not to be taken by way of limitation, the spirit and scope of the present invention being limited only by the terms of the appended claims.

1. A thermal transfer printer comprising:
a thermal head contactable with a sheet of paper to heat a side of the sheet;
a platen disposed opposite said thermal head to press the sheet onto said thermal head;
a rotatable transport roller located downstream from said thermal head with respect to the process of heating the sheet with said thermal head, the transport roller transporting the sheet held between said thermal head and said platen to be pulled out;
a pinch roller disposed opposite said transport roller to press the sheet onto said transport roller;
a decurling roller located between said thermal head and said transport roller, the decurling roller being contactable with the heated side of the sheet heated by said thermal head, thereby curving the sheet with its heated side being concaved; and
a guide roller located between said thermal head and said decurling roller, the guide roller being contactable with a side of the sheet opposite the heated side,
wherein said transport roller is contactable with the side of the sheet opposite the heated side, and
the sheet is a sheet of thermal paper provided with a layer of heat sensitive dye which, when irradiated with ultraviolet light, allows an image formed by the heating by the thermal head to be fixed.

2. A thermal transfer printer comprising:
a thermal head contactable with a sheet of paper to heat a side of the sheet;
a platen disposed opposite said thermal head to press the sheet onto said thermal head;
a rotatable transport roller located downstream from said thermal head with respect to the process of heating the sheet with said thermal head, the transport roller transporting the sheet held between said thermal head and said platen to be pulled out;
a pinch roller disposed opposite said transport roller to press the sheet onto said transport roller; and
a decurling roller located between said thermal head and said transport roller, the decurling roller contactable with the heated side of the sheet heated by said thermal head to curve the sheet with its heated side being concaved.

3. The thermal transfer printer according to claim 2, wherein a guide roller is provided between said thermal head and said decurling roller, the guide roller being contactable with a side of the sheet opposite the heated side.

4. The thermal transfer printer according to claim 2, wherein said transport roller is contactable with a side of the sheet opposite the heated side.
